(19) United States
(12) Patent Application Publication
(10) Pub. No.: US 2007/0283946 A1
(43) Pub. Date: Dec. 13, 2007

(54) Barbecue cover assembly

(76) Inventors: Walter Fiore Maruzzo, Oakville (CA); Michael Matthew Conroy, Ajax (CA)

Correspondence Address: GOWLING, LAFLEUR HENDERSON LLP, ONE MAIN STREET WEST, HAMILTON, ON, L8P 4Z5, US

(21) Appl. No.: 11/448,081

(22) Filed: Jun. 7, 2006

(51) Int. Cl. F24B 3/00; F24C 3/00; F24C 15/08; B65D 65/02; A47J 37/00; B65D 85/00

(52) U.S. Cl. 126/50; 126/25 R; 126/41 R; 150/154; 150/165

(57) ABSTRACT

A barbecue cover assembly includes a container having a base, walls moveable between an erected configuration and an outwardly collapsed configuration, and an actuating member operable to retain the walls in the erected configuration and to permit outward movement of the walls to the collapsed configuration. A barbecue cover is housed within the container. The cover assembly is positionable on top of a barbecue whereby the actuating member can be operated to permit movement of the walls to the outwardly collapsed configuration and thus permits the cover to be deployed to a barbecue covering position.

### FIELD OF INVENTION

This invention relates to barbecue covers.

### BACKGROUND OF THE INVENTION

It is usual to position a cover over a barbecue when the barbecue is not in use, and many different kinds of barbecue covers are known for this purpose. However, known barbecue covers are not easy to fit onto and to remove from a barbecue and are also cumbersome and unsightly when not in use.

It is therefore an object of this invention to provide a barbecue cover assembly which at least substantially overcomes the problems mentioned above.

### SUMMARY OF THE INVENTION

According to the invention, a barbecue cover assembly includes a container having a base, walls moveable between an erected configuration and an outwardly collapsed configuration, and an actuating member operable to retain the walls in the erected configuration and to permit outward movement of the walls to the collapsed configuration, and a barbecue cover housed within the container, said assembly being positionable on top of a barbecue whereby the actuating member can be operated to permit movement of the walls to the outwardly collapsed configuration to permit the cover to be deployed to a barbecue covering position.

The actuating member may comprise a cord connected to the container walls, and the cover may comprise portions which are detachably connected together after deployment. The container may also have a lid.

### DESCRIPTION OF THE DRAWINGS

One embodiment of the invention will now be described, by way of example, with reference to the accompanying drawings, of which:

FIG. 1 is a perspective view of a barbecue cover assembly in accordance with the invention located on top of a barbecue, the lid of the container having been opened,

FIG. 2 is a similar view with the lid folded back and the actuating cord being held for release,

FIG. 3 is a similar view showing the walls of the container in their outwardly collapsed configuration,

FIG. 4 is a similar view showing the barbecue cover partially deployed,

FIG. 5 is a similar view showing the barbecue cover fully deployed,

FIG. 6 is an enlarged perspective view of the left side portion of the cover being zipped to the main portion of the cover,

FIG. 7 is a similar view showing the zipping almost completed,

FIG. 8 is a perspective view of the barbecue cover in place over the barbecue,

FIG. 9 is a perspective view of the left side portion of the cover being unzipped from the main portion,

FIG. 10 is a similar view showing the unzipping nearly completed,

FIG. 11 is a perspective view showing the initial stage of folding the cover back onto the base of the container,

FIG. 12 is a similar view of a further stage, with the actuating cord being pulled to bring the container walls to the erected configuration,

FIG. 13 is a similar view showing the cover substantially fully contained in the container, and

FIG. 14 is a perspective view showing the container in its erected configuration with the cover fully contained therein and the lid about to be closed.

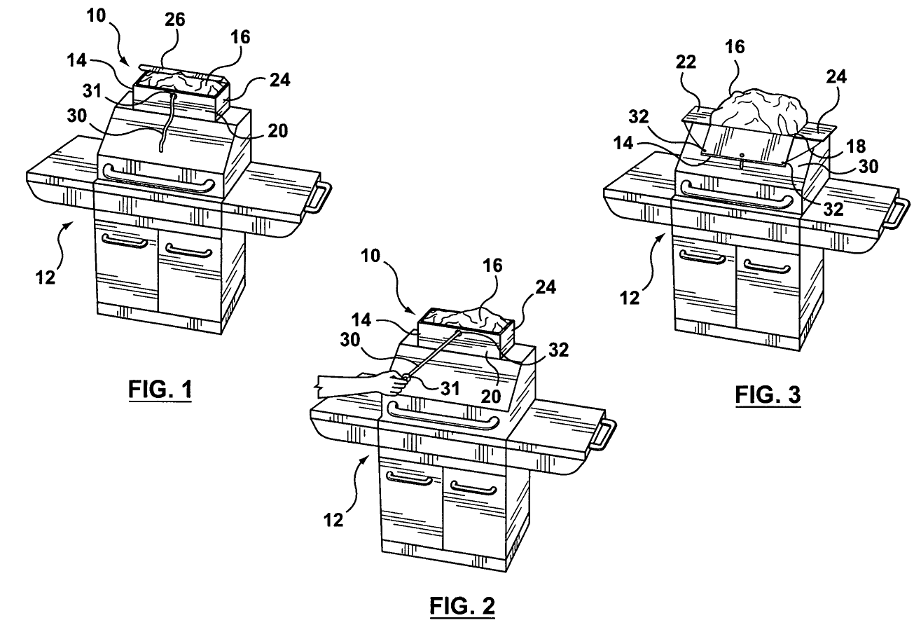

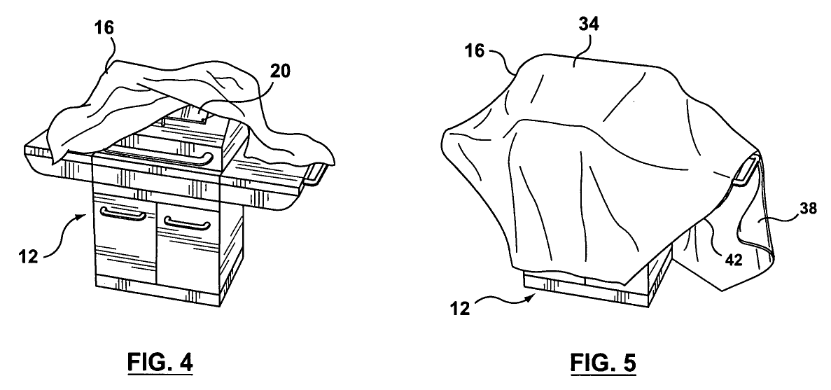

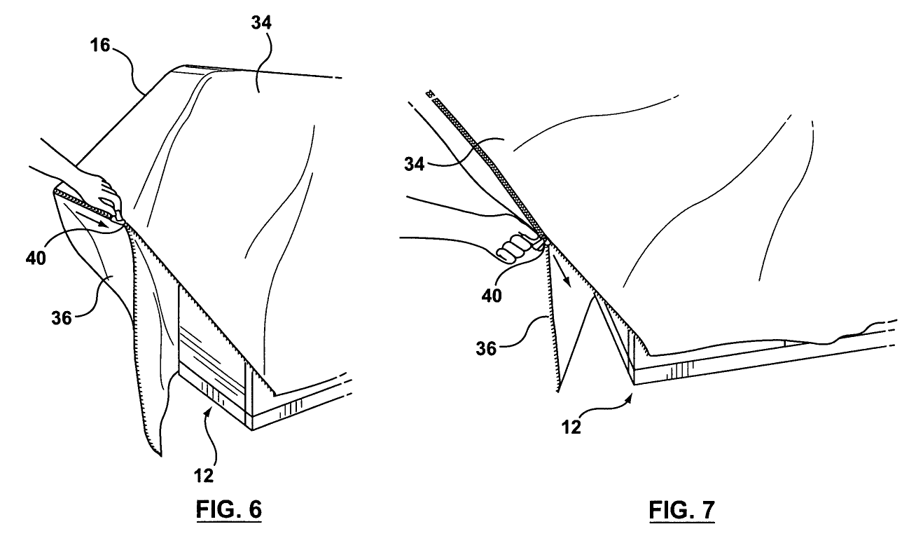

Referring to the drawings, FIG. 1 shows a barbecue cover assembly 10 in accordance with the invention located on top of barbecue 12. The barbecue cover assembly 10 includes a rectangular box-like container 14 and a barbecue cover 16. The container 14 has a base 18 (see FIG. 3), a front wall 20, side walls 22, 24 and a rear wall (not shown). The container 14 also has a lid 26 attached to the rear wall. The walls are hingedly connected to the base 18 but not to the other walls. The walls are held in the erected configuration shown in FIGS. 1 and 2 by an actuating member in the form of a cord 30 which extends around the upper ends of the walls and passes through apertures 32 therein. The cord 30 is provided with a slider 31 which retains the walls in the erected configuration. To cover the barbecue 12, the barbecue cover assembly 10 is placed on top of the barbecue 12 and the lid 26 opened, as shown in FIG. 1. The actuating cord 30 is then operated by sliding back slider 31, as shown in FIG. 2, to permit the container walls to fall outwardly to a collapsed configuration to expose the barbecue cover 16, as shown in FIG. 3. The operator then deploys the barbecue cover 16, as shown in FIGS. 4 and 5.

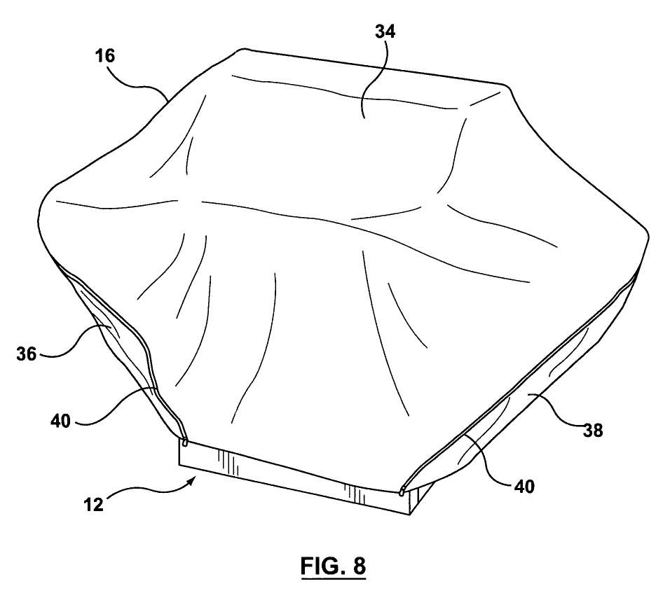

As shown in FIGS. 5 to 7, the cover 16 has a main portion 34 and left and right side portions 36, 38 which are detachably connectable by zippers 40, 42 to the main portion 34 after deployment. The main portion 34 of the cover 16 is secured to the base 18 of the container 14, for example by Velcro strips (not shown). FIG. 8 shows the cover 16 in its fully deployed and assembled condition covering the barbecue 12.

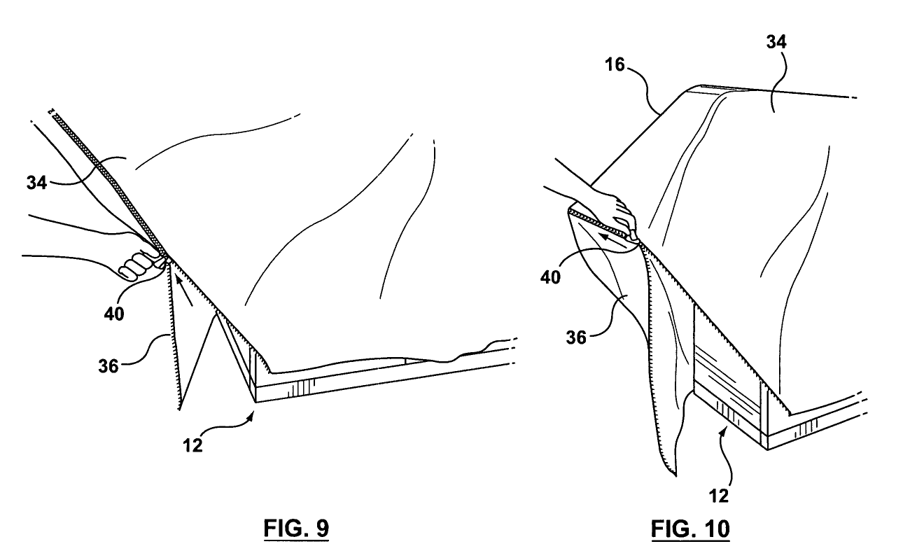

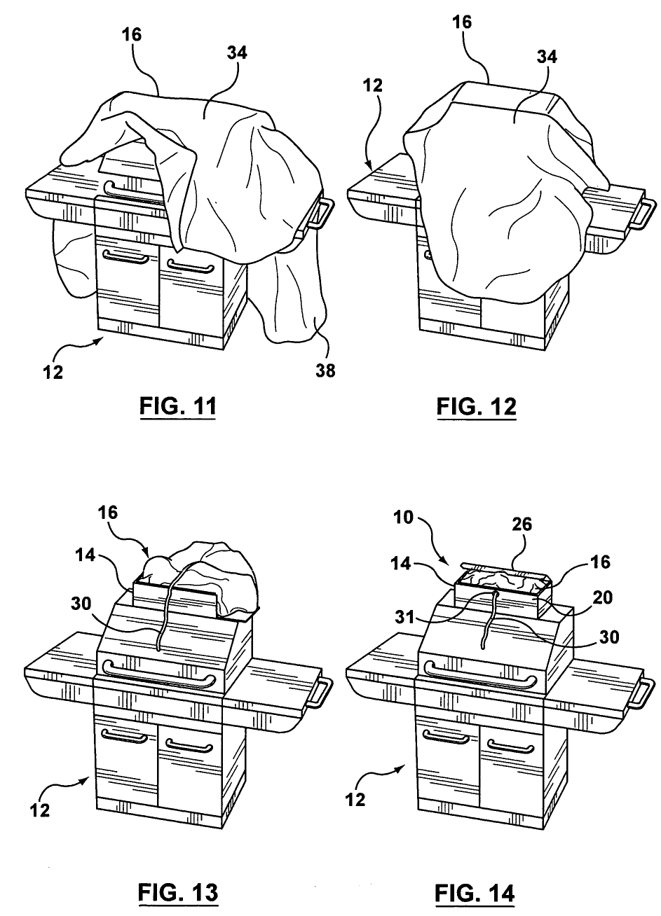

Removal of the cover 16 is essentially reversal of the deployment procedure previously described. The side portions 36, 38 are unzipped as shown in FIGS. 9 to 11, the cover 16 is folded onto the top of the barbecue as shown in FIGS. 11 to 13, the actuating cord 30 is pulled to re-erect the container 16 as shown in FIG. 13, the slider 31 being slid along the cord 30 to abut the front wall 20 of the container 16, and the lid 26 is closed as indicated in FIG. 14.

It will be noted that a barbecue cover assembly 10 in accordance with the invention can be very easily deployed on and removed from a barbecue and also that it provides easily portable and effective storage for the barbecue cover 16 when not in use.

Other embodiments and advantages of the invention will now be readily apparent to a person skilled in the art, the scope of the invention being defined in the appended claims.

What is claimed is:

1. A barbecue cover assembly including a container having a base, walls moveable between an erected configuration and an outwardly collapsed configuration, and an actuating member operable to retain the walls in the erected configuration and to permit outward movement of the walls to the collapsed configuration, and a barbecue cover housed within the container, said assembly being positionable on top of a barbecue whereby the actuating member can be operated to permit movement of the walls to the outwardly collapsed configuration to permit the cover to be deployed to a barbecue covering position.

2. A barbecue cover assembly according to claim 1 wherein the actuating member comprises a cord connected to the container walls.

3. A barbecue cover assembly according to claim 1 wherein the cover comprises portions detachably connectible together after deployment.

4. A barbecue cover assembly according to claim 1 wherein the container also has a lid.

5. A method of covering a barbecue including providing a barbecue cover assembly in accordance with claim 1, and operating the actuating member to permit movement of the walls to the outwardly collapsed configuration to enable the cover to be deployed to a barbecue covering position.

6. A method according to claim 5 wherein the actuating member comprises a cord connected to the container walls.

7. A method according to claim 5 wherein the cover comprises portions which are detachably connected together after deployment.

8. A method according to claim 5 wherein the container also has a lid which is opened prior to operation of the actuating member.
